(19) United States
(12) Patent Application Publication
(10) Pub. No.: US 2014/0006135 A1
(43) Pub. Date: Jan. 2, 2014

(54) Social Currency And Method Of Using The Same

(71) Applicant: Joel Eben Vergun, Hallandale Beach, FL (US)

(72) Inventor: Joel Eben Vergun, Hallandale Beach, FL (US)

(21) Appl. No.: 13/929,260

(22) Filed: Jun. 27, 2013

Related U.S. Application Data
(60) Provisional application No. 61/665,743, filed on Jun. 28, 2012.

(51) Int. Cl. G06Q 30/02

(52) U.S. Cl. CPC G06Q 30/0226; G06Q 30/0279
USPC 705/14.27

(57) ABSTRACT

A method to provide a currency in a commercial environment, wherein the currency generates support for non-profit organizations, and advertises participating businesses. The method steps comprise: establishing a reserve bank for the currency; soliciting non-profit organizations to utilize the currency; soliciting businesses to utilize the currency and to sponsor the non-profit organizations; supplying an initial amount of the currency to the non-profit organizations and the businesses, wherein the initial amount of the currency that businesses receive is a function of a level of sponsorship that the respective businesses provide to the non-profit organizations; encouraging businesses to advertise on the currency; encouraging the businesses to donate the currency to the non-profit organization; encouraging the non-profit organizations to provide the currency to individuals in return for donations to the non-profit organizations; and encouraging the individuals to exchange the currency with the businesses in return for goods and services.

### CROSS-REFERENCE TO RELATED APPLICATIONS

This application claims the priority benefit of U.S. Provisional Application 61/665,743 filed Jun. 28, 2012, which is herein incorporated by reference in its entirety.

### TECHNICAL FIELD

The present disclosure relates to the field of alternate currencies. More particularly, the disclosure discusses a social currency and method of use.

### BACKGROUND

Donors to non-profit organizations, charities and other “worthy causes” are also consumers of goods and services (in this role, the donor is referred to as “consumer” or, when interacting with a participating business, “customer”). Some donors own or manage local retail businesses (in this role, the donor is referred to as “business,” “merchant,” or “retailer.”). While it is idealistic to think that all donors have only altruistic intentions, the truth is that most donors prefer to receive something in return. Hence, non-profit organizations which solicit donations continually search for donor incentives. For example, a non-profit theater may provide discounted seats for a modest annual donation. For a larger donation, the same non-profit theater may emboss the donor's name on a seat within the theater. A business owner may make a donation to the theater to have his business card or ad printed in the playbill or program, in the hope that other theater patrons will notice the business' support of the theater and then later remember and patronize the business. In short, nonprofits and their donors use a barter system to exchange donations for services and recognition. Just as the invention of money long ago replaced barter and greatly facilitated the for-profit economy, a “social currency” would facilitate the exchange of goods, services, and good works in the non-profit sector, to the benefit of the society as a whole.

### BRIEF SUMMARY OF THE INVENTION

The method to provide a currency in a commercial environment comprises: establishing a reserve bank for the currency; soliciting non-profit organizations to utilize the currency; soliciting businesses to accept the currency, and optionally, to sponsor non-profit organizations; supplying an initial amount of the currency to participating non-profit organizations and businesses, wherein the initial amount of the currency that businesses receives is a function of either the level of sponsorship that respective businesses provide to the sponsored non-profit organizations, or an amount of the social currency that a given business can be expected to accept; encouraging the businesses to donate the currency to the non-profit organizations for their reuse; encouraging the non-profit organizations to provide the currency to individuals in return for donations; and encouraging individual consumers to exchange the currency with the businesses in return for goods and services.

In a separate embodiment, wherein businesses do not sponsor a specific nonprofit organization, the reserve bank determines the non-profit organizations which receive a sponsorship benefit.

In a separate embodiment, the businesses print advertising on the currency.

In a separate embodiment, the method further comprises encouraging individuals to donate the currency to non-profit organizations.

In a separate embodiment, the reserve bank maintains an exchange rate between the currency and a common medium of exchange such as U.S. Dollars or the like.

In a separate embodiment, the reserve bank provides a non-profit discount rate to the exchange rate to selected non-profit organizations. The discount rate enables a non-profit organization to raise funds by offering the social currency to the public at a higher price than it cost the organization to obtain the currency from the reserve bank.

In a separate embodiment, the reserve bank provides a business discount rate to the exchange rate to selected businesses. This enables the selected businesses to print advertising upon the currency, distribute or sell the currency bearing their advertisement, or donate or sell the ad-bearing currency to nonprofits for them to distribute or sell to potential customers of the business.

In a separate embodiment, businesses can purchase advertising on currency issued from the reserve bank to non-profit organizations or consumers.

In a separate embodiment, the reserve bank sells the currency to individuals at the exchange rate. This direct-to-consumer sale of the currency could benefit a specific nonprofit selected by the consumer, and advertise participating businesses.

In a separate embodiment, individuals can donate the currency to non-profit organizations.

In a separate embodiment, the businesses can accept the currency in combination with a common medium of exchange (such as U.S. Dollars) for the goods or services.

In a separate embodiment, the currency comprises both physical forms, such as paper or coin, and electronic forms, such as QR codes or other methods of display and exchange facilitated by electronic devices. In an electronic embodiment, advertising would be displayed to users at appropriate opportunities, rather than being “printed” on the currency.

In a separate embodiment, the currency can have a “redeem by” or “reuse through” date, beyond which the exchange of the currency at participating businesses is restricted. The restriction can be a requirement to exchange the currency at reserve bank at a predetermined exchange rate, or a requirement to donate the currency to a participating nonprofit.

In a separate embodiment, the currency can have a maturity date, which may be the same or different than the expiration date, after which the reserve bank will exchange the matured currency for an amount money (the amount to be set by the reserve bank), or the bank may offer to exchange the mature currency for new currency

The scope of the invention is defined by the claims, which are incorporated into this section by reference. A more complete understanding of embodiments on the present disclosure will be afforded to those skilled in the art, as well as the realization of additional advantages thereof, by consideration of the following detailed description of one or more embodiments. Reference will be made to the appended sheets of drawings that will first be described briefly.

The following detailed description of the invention is merely exemplary in nature and is not intended to limit the invention or the application and uses of the invention. Furthermore, there is no intention to be bound by any theory presented in the preceding background of the invention or the following detailed description of the invention.

In this application, the following terms are used to distinguish the social currency from the common economic currency: for the social currency, the terms “DishFish,” “DishFish Dollars,” “DishFish coupons” or “$DF;” for the economic currency, the terms “U.S. Dollars” or “$US”. This choice of terms does not restrict the names that may be applied to the social currency, nor restrict the economic currency with which the social currency may be exchanged to the U.S. dollar.

### BRIEF DESCRIPTION OF THE DRAWINGS

FIG. 1 is a diagram which shows the flow of DishFish Dollars ($DF) and U.S. Dollars ($US) between different types of entities.

FIG. 2 is a front view of one DishFish.

FIG. 3 is a front view of six DishFish dollars, $1 coupons.

FIG. 4 is a diagram which shows an alternate embodiment of the flow of DishFish Dollars ($DF) and U.S. Dollars ($US) between different types of entities.

FIG. 5 shows Step 1: Introducing DishFish Dollars ($DF) to a community.

FIG. 6 shows Step 2: DishFish Dollars distributed/sold to businesses, organizations, and consumers.

FIG. 7 shows Step 3: $DF sold or distributed to consumers by local businesses and organizations.

FIG. 8 shows Step 4: Consumers spend/redeem $DF at participating businesses.

FIG. 9 shows Step 5: Redeeming businesses reuse $DF, and may affix ads to them.

FIG. 10 shows Step 6: Unexpired DishFish Dollars circulate as social currency, advertising participating businesses.

FIG. 11 shows Step 7: Expired (or otherwise unusable) $DF are donated, cashed-in, or exchanged for new $DF.

FIG. 12 shows the steps of a method embodiment.

### DETAILED DESCRIPTION OF THE INVENTION

Certain non-profits, by their nature, have little they can offer as barter to encourage donations. For example, wealthy donors to a homeless shelter would never expect a free night's stay at the shelter in return for their donation. The homeless shelter could benefit from having an incentive for donors which doesn't depend on the shelter's core competency of offering room and board to the destitute.

Many non-profit organizations employ “development” personnel whose primary job is to solicit donations. If the organization lacks natural donor incentives, the dedicated personnel create separate incentives. Examples are Winefest (Ann Arbor Art Association) and the Kidney Ball (National Kidney Foundation of Michigan). While these separate incentives are successful in motivating donors, they require a large overhead cost (mostly in personnel) that the non-profit must maintain.

Organizations also solicit donations directly from businesses. Similar to individuals, businesses expect something in return for their donation, usually in the form of advertising, recognition or, goodwill that the business hopes will result in greater patronage of the business by supporters of the organization. But any additional patronage that results is difficult or impossible to quantify. In fact, successfully creating business goodwill is usually more complex than hosting events such as Winefest or the Kidney Ball. The non-profit organization must be able to communicate to its supporters both the names of businesses worthy of goodwill, and a reason for supporters to patronize those businesses.

Hence, a need exists for non-profits to be able to easily create donor incentives that identify the businesses that have donated to the organization, give consumers an incentive to shop at those businesses, and give the businesses a way to measure the effectiveness of their donations in generating additional revenue. This is especially true for non-profits that don't have natural incentives available. To be most effective, donor incentives should be easily transferable and should be available to both individuals and businesses.

The present disclosure describes a social currency, DishFish Dollars™ ($DF), which fulfills the needs described above. The currency enables a non-profit organization to distribute (or sell as a fundraiser) $DF to donors as an incentive/reward for donations of cash, in-kind contributions, volunteering of time, or the like. The donor (as consumer) would be able to spend (or “redeem,” to borrow the terminology associated with discount coupons) their $DF at any business willing to accept $DF as full or partial payment for goods or services. The business may, in turn, spend the reusable $DF they receive from customers at other participating businesses, give the $DF as incentives to valued employees, offer the $DF to customers as an incentive to return, or donate the $DF to a non-profit organization of their choosing. The receiving organization may then reuse those $DF as incentives for donors, completing the cycle. The complexities involved in creating and maintaining the $DF cycle are discussed below.

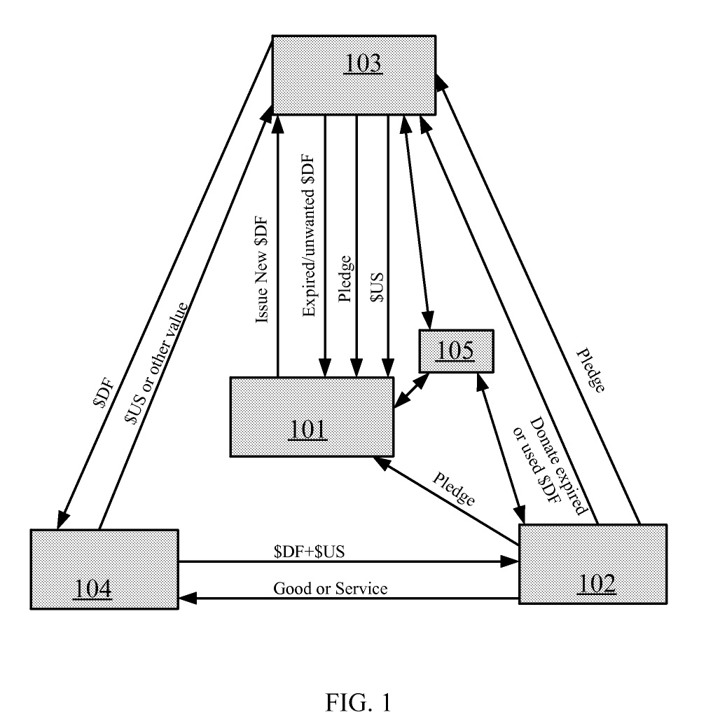

FIG. 1 is a diagram which shows the flow of DishFish Dollars ($DF) and U.S. Dollars ($US) between different types of entities. Shown in the center of a triangle is a reserve bank 101, the administrative entity responsible for producing and distributing $DF to nonprofits and maintaining the $DF money supply in circulation in a given local market at a usable level. On the three corners of the triangle are a business 102, a non-profit organization 103 (also referred to herein as “charity,” “organization” or “worthy cause”), and a consumer 104. The reserve bank 101 maintains and regulates the supply of $DF. Demand for $DF is created when a business 102 pledges to accept $DF from customers (consumers 104). The over-riding purpose of pledges is to help regulate the amount of $DF available, so that there is a balance between supply and demand. The pledge is made either for the benefit of a specific non-profit organization 103, or, if the business does not specify a beneficiary organization, the reserve bank 101 may use the surplus demand created by the unspecified pledge to offer a grant of $DF to a nonprofit in the business' market that the reserve bank chooses to sponsor. If the non-profit organization 103 received the pledge, the non-profit organization 103 conveys the pledge to the reserve bank 101. The reserve bank 101 issues an amount of $DF which equals the pledge amount to the non-profit organization 103. In one embodiment, the reserve bank 101 can issue $DF to the business 102. Note that the pledge is a promise by the business to accept $DF from consumers under terms which the business 102 and reserve bank 101 find acceptable. So as to be of greatest benefit and least liability to the business, the business is granted great leeway in constructing a “deal” that will attract consumers yet still serve the unique needs of the business. For example, a business may accept 20% of payment for a service in $DF, with the remaining 80% payable in $US. Or a business may accept $DF only for items that the business is currently overstocked. Social media and word-of-mouth among consumers suffice to ensure that businesses that construct the most generous deals attract the most consumers. The business can thus regulate the quantity of $DF that customers bring them by making the “deal” more attractive or less attractive. Alternately, a business could choose to accept only a limited amount of $DF or accept $DF for only a limited time.

In another embodiment, the flow of DishFish Dollars ($DF) and U.S. Dollars ($US) between different types of entities is facilitated by an agent 105. The agent 105 can be an individual, business or organization that has knowledge of and contacts with charities 103 and merchants 102 in a specified area of responsibility (a geographic area, vertical market, or membership group in which the agent has knowledge, contacts or influence). The agent acts on behalf of, or as an intermediary for, the reserve bank 101. Agents 105 may: determine the authenticity and eligibility of charities and merchants according to their own criteria; ensure merchants and charities operate within the policies outlined by the reserve bank; aggregate and make a market in pledges and $DF so that $DF can be ordered and distributed in economic quantities; buy $DF from the reserve bank for distribution to merchants and charities; be licensed to print their own $DF; be licensed to label $DF with their own brand; sell advertising on $DF; and sell or distribute $DF to merchants, charities and consumers to raise revenue or to accomplish other purposes.

The non-profit organization 103 conveys a combination of pledges, $US, expired $DF, damaged $DF, and unwanted $DF (e.g. want different denominations) to the reserve bank 101. In return, the reserve bank 101 issues $DF to the non-profit organization 103. In one embodiment, the reserve bank 101 can pay $US back to the non-profit organization 103 for $DF. This is done at an exchange rate determined by the reserve bank 101.

The donor 104 donates $US or something else of value to the organization 103 (e.g. used clothing, or volunteer time). In return, the non-profit organization 103 gives $DF to the donor 104.

The donor 104 uses $DF as partial payment (or in some embodiments, full payment) to the business 102. In return, the business 102 provides a good or service to the donor 104. $DF then enter general circulation until they expire (or pass their redeem by date), mature, become unusable, or are returned to the reserve bank in exchange for more $DF or some $US. This completes the virtuous cycle of $DF.

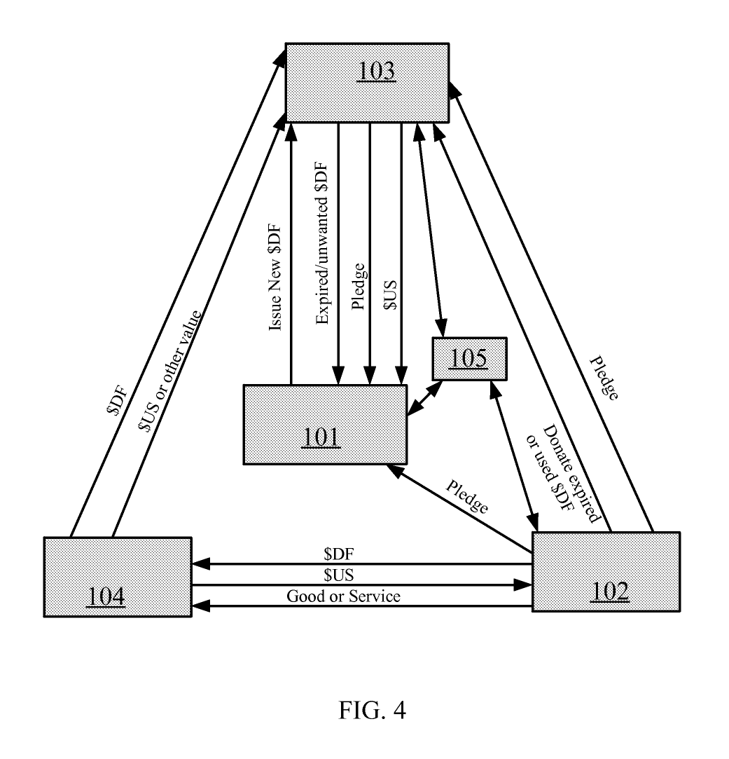

FIG. 4 is a diagram which shows an alternate embodiment of the flow of DishFish Dollars ($DF) and U.S. Dollars ($US) between different types of entities. In this embodiment, a business 102 offers $DF to a customer 104 as an incentive or reward (instead of accepting $DF in exchange for a discount). The customer 104 then donates the $DF to a non-profit organization 103.

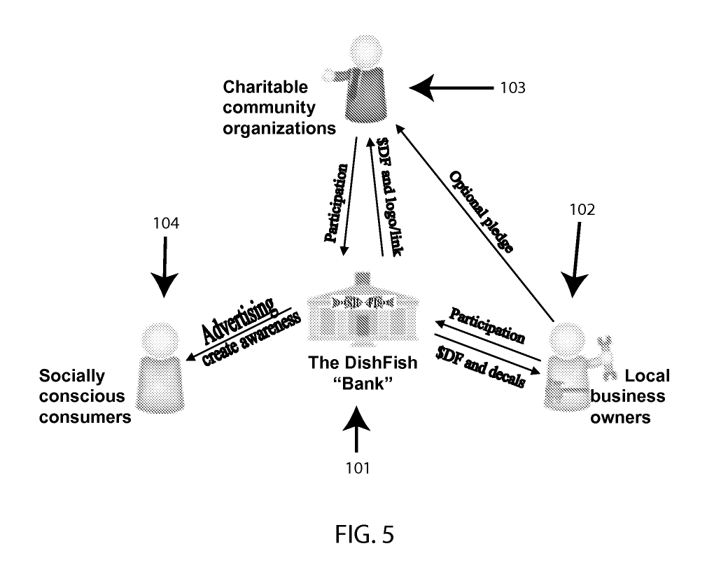

FIG. 5 shows Step 1: Introducing DishFish Dollars ($DF) to a community.
1. To gain a foothold in a new community, the DishFish bank and its partners solicit participation from community charities and local business owners.
2. Businesses receive DishFish Decals to place on windows and cash registers. Organizations and businesses may place a DishFish logo on their web sites.
3. Participating businesses and organizations receive a “starter supply” of $DF.
4. A business may sponsor a favorite organization. Sponsored organizations are offered additional $DF beyond the starter supply. The business specifies the beneficiary organization (the organization they are sponsoring) by clicking on the DishFish logo on the organization's web site. If the business does not select an organization, the DishFish bank chooses an organization in the community to sponsor.
5. Participating businesses and organizations are listed on the DishFish web site. Consumers use the site to learn where to get and spend $DF.
6. The DishFish program, along with the names of participating organizations and businesses, are advertised in the local press.

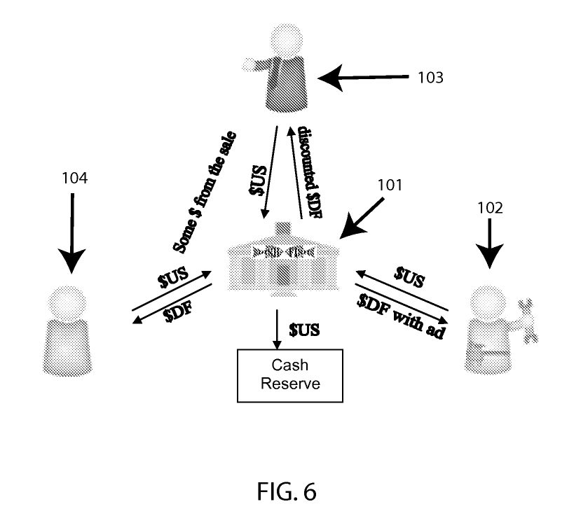

FIG. 6 shows Step 2: DishFish Dollars distributed/sold to businesses, organizations, and consumers.
1. Organizations may opt to buy $DF in bulk from the bank at a considerable discount from face value, usually to re-sell as fundraisers (see Step 3).
2. Businesses that accept $DF may buy $DF in moderate quantities from the bank at a discount. These $DF may have an ad for the business pre-printed on the back (paper $DF) or displayed on-screen (electronic $DF).
3. A business or organization may purchase advertising on $DF without purchasing the accompanying $DF. The ads will appear on $DF sold by the bank to consumers or organizations.
4. The bank sells $DF to consumers online at the regular price. A portion of the proceeds goes to an organization of the consumer's choice.
5. A consumer “chooses” the organization to donate to by clicking on the DishFish logo on the organization's web site, or from a link or logo on a web site, blog or email of a supporter of the organization. (A code identifying the organization is embedded in the link.) The link brings the consumer to the DishFish web site where the consumer can purchase $DF; the chosen organization is noted, and revenue from the sale is shared with the organization.
6. Surplus revenue from sales of $DF is held in reserve by the bank.

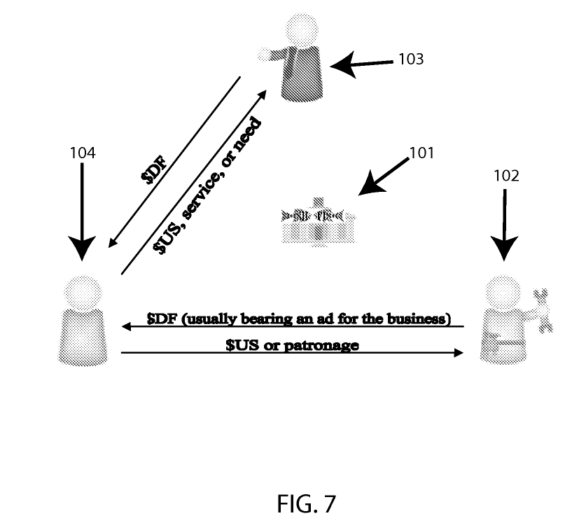

FIG. 7 shows Step 3: $DF sold or distributed to consumers by local businesses and organizations.
1. Organizations and businesses distribute $DF locally to consumers by giving $DF away or selling them. (Organizations may use $DF for any lawful purpose that is within the rules specified by the bank, including: selling $DF to consumers as a fundraiser; giving $DF to donors and volunteers as thanks; giving $DF to people in need; offering $DF at a discount to persons who then earn money selling $DF to consumers; or selling their surplus $DF to other organizations.)
2. Participating businesses (those that accept $DF) may advertise on $DF and distribute them, by offering the $DF to customers as an incentive to return, using the $DF like advertising coupons, or by selling the $DF.

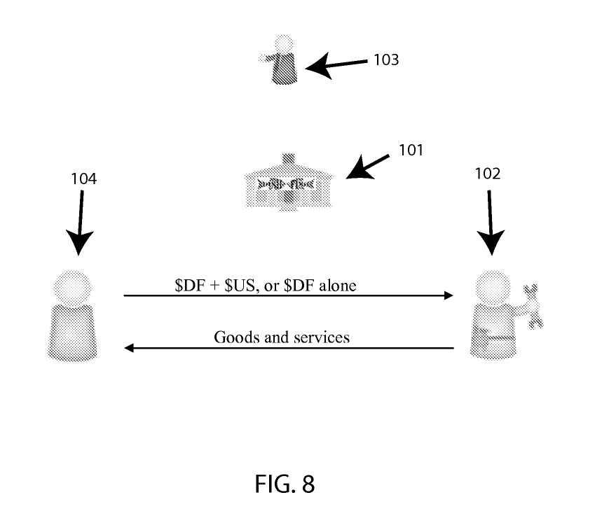

FIG. 8 shows Step 4: Consumers spend/redeem $DF at participating businesses.
1. Consumers locate participating businesses by consulting a list on the DishFish web site, by noticing a DishFish logo or decal posted at a participating business, or by clicking the DishFish logo on the web site of a favorite community organization (which takes them to the DishFish web site and a list of participating businesses, featuring those businesses which have sponsored the organization.)
2. Businesses craft a “DishFish Deal” that serves the needs of the business and provides an incentive to consumers. The deal may be a simple dollar-for-$DF discount, or something more creative that better serves the business. Prosperous local businesses are good for communities; and one of the goals of $DF is to increase revenue for local businesses, not to cannibalize their sales.
3. Typically, $DF are redeemed in combination with $US (or the local economic currency), like a dollar-off coupon. However, businesses may accept payment solely in $DF if they wish.
4. Participating businesses agree to offer the customer at least $1 US in retail value in exchange for each $1 DF, but the business may limit redemption of $DF in ways that enhance the business' revenue. Limits such as one $DF per customer; minimum purchase required; not valid with other offers; get a large for the price of a small; buy two and get a third for $1 DF; etc., are permitted and encouraged.
5. The business may change their DishFish Deal as often as they wish, and may give discounts of greater value on some items, and less on others. This makes $DF far more flexible than discount coupons which advertise a specific discount.

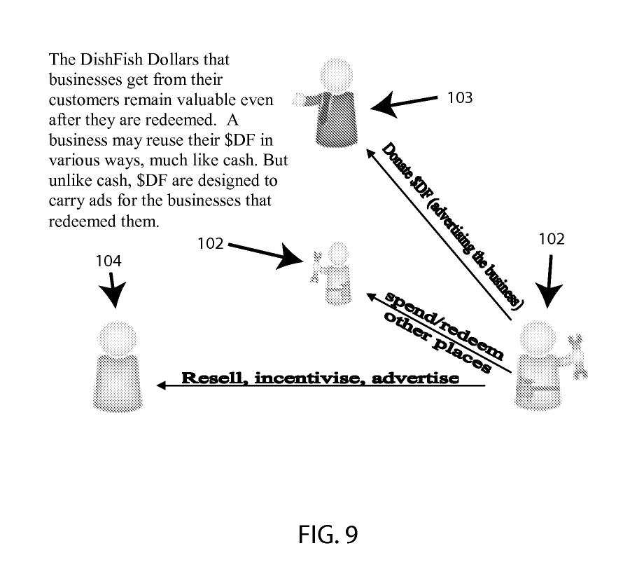

FIG. 9 shows Step 5: Redeeming businesses reuse $DF, and may affix ads to them.
1. The redeeming business may advertise on the redeemed $DF. Existing ads from previous businesses may be replaced with an ad for the business that now holds the $DF, by covering [on paper $DF] the previous ad with a sticker (the business would keep a supply of advertising stickers for this purpose), or [on electronic $DF] any previous ad is automatically replaced with an ad for the business that most recently redeemed the $DF. The ad is placed on the back of the $DF [paper], or [electronic] displayed to the consumer when the $DF is transacted or viewed, or at other opportune times.
2. The business may
   A. redeem $DF at other participating businesses.
   B. offer $DF to good customers as an incentive to return.
   C. reward employees with $DF.
   D. donate $DF to a favorite charity or community organization.
   E. use their $DF for any other permitted purpose.

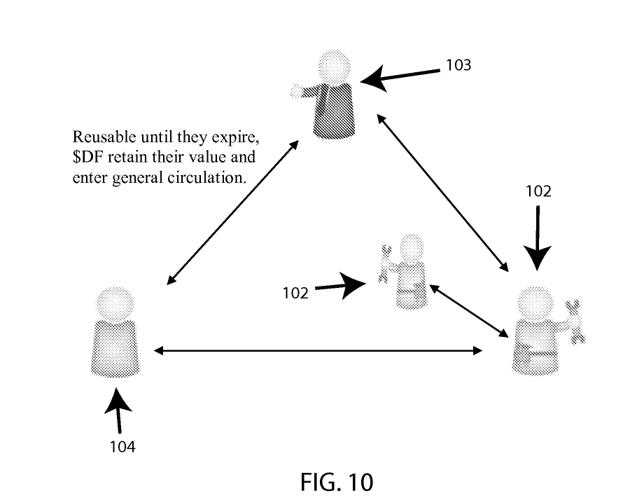

FIG. 10 shows Step 6: Unexpired DishFish Dollars circulate as social currency, advertising participating businesses.
1. $DF donated to organizations can be re-used, or sold again to raise more funds.
2. Circulating $DF increase the local money supply, encouraging spending at local businesses and incentivizing volunteerism and donations to community organizations.
3. Reusability means less reprinting. $DF are thus better for the environment than single-use coupons.
4. Because $DF are accepted many places, consumers are more likely to carry $DF in their wallets or use a $DF mobile app, than they would a typical paper discount coupon or mobile app good at only a single merchant. This gives $DF an advantage over these other forms of advertising. $DF will get more of the consumers' attention, and be more valuable as an advertising platform. Every time the consumer opens his wallet, he see the $DF and the ads for participating businesses, and is reminded to shop where a DishFish logo is displayed.

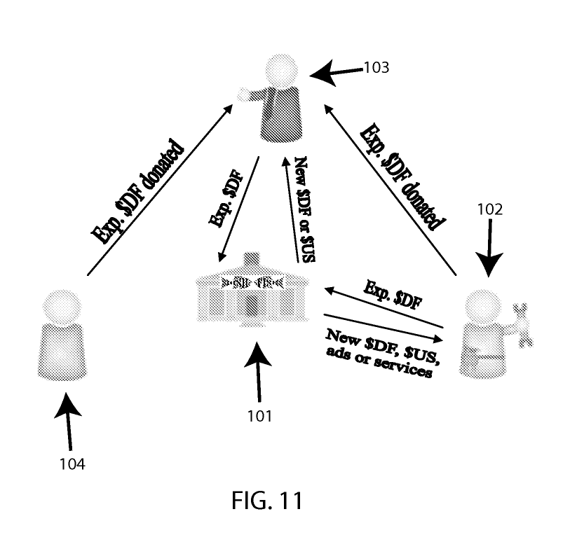

FIG. 11 shows Step 7: Expired (past its redeem by date), matured or unusable $DF are donated, cashed-in, or exchanged for new $DF.
1. “Reuse through [expiration date] then give to charity” (or similar wording) is printed on the front of every paper $DF. Electronic $DF expire after a specified interval if not circulated (similar to loyalty rewards programs whose points expire if not redeemed within a certain time period).
2. Expired $DF (in some embodiments) may not be redeemed at a business unless the business permits it. (Where the law requires instruments like $DF to be valid for a longer period, the consumer may be given the option to exchange expired $DF for newer ones.)
3. Expired $DF may be donated to a favorite organization. The organization can trade them in for new $DF to sell, or cash them in.
4. Because the consumer or business holding the expired $DF decides which organization to donate the $DF to, the participating businesses and consumers, not the reserve bank, decide which organizations are worthy of support.
5. Businesses and organizations may cash-in $DF for $US at an exchange rate set by the reserve bank. (This exchange rate, the “buy rate,” will typically be much less than face value. Most of the money originally collected has already gone to organizations, and money is needed to support the operations of the bank, and to promote the program.) The $US are paid out from the bank's reserves.
6. The bank will solicit charities or governmental entities such as a Community Fund or Downtown Development Authority, to become the bank's partners or agents. The partner/agent may budget additional $US to increase the cash-in value of $DF. The partner/agent may restrict which organizations or businesses are eligible to cash-in $DF with them for the increased amount.
7. Businesses and organizations may exchange expired $DF for new ones, paying only a small fee to the bank to cover printing, distribution and administration.
8. Businesses and organizations may use expired $DF to pay for advertising or other services offered by the DishFish bank.

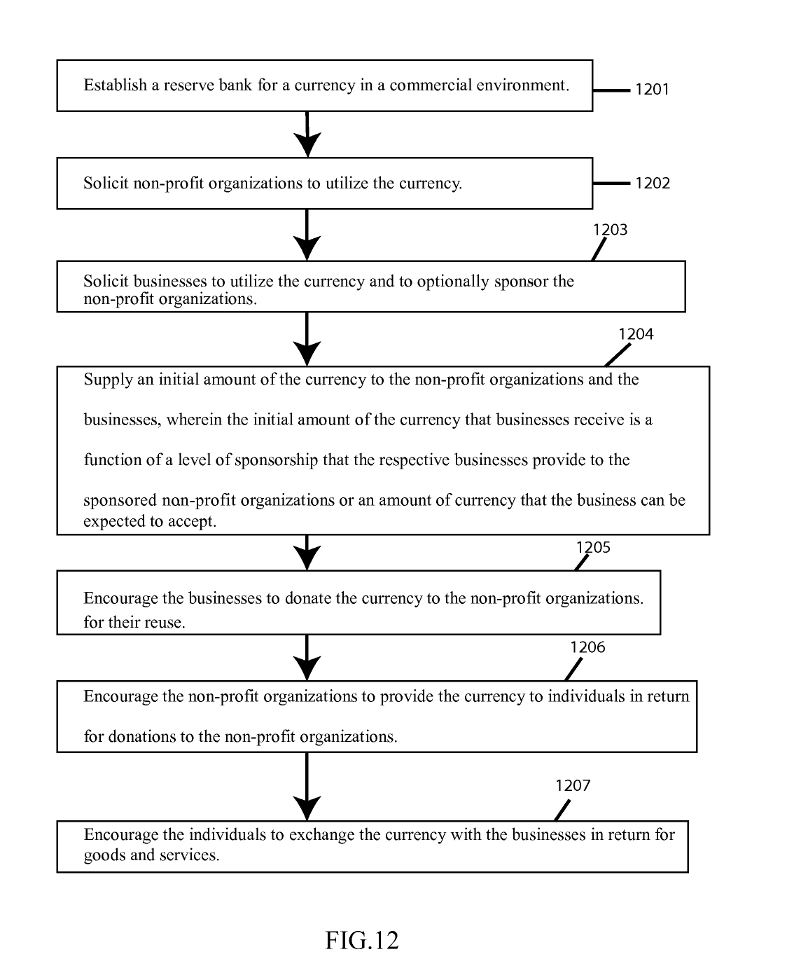

FIG. 12 shows the steps of a method embodiment. Shown are Step 1201, establishing a reserve bank for the currency; Step 1202, soliciting non-profit organizations to utilize the currency; Step 1203, soliciting businesses to utilize the currency and to sponsor the non-profit organizations; Step 1204, supplying an initial amount of the currency to the non-profit organizations and the businesses, wherein the initial amount of the currency that businesses receives is a function of a level of sponsorship that respective businesses provide to the non-profit organizations (in practice, a function of the amount of $DF the business can reasonably be expected to accept from consumers over a given period of time); Step 1205, encouraging the businesses to donate the currency to the non-profit organizations; Step 1206, encouraging the non-profit organizations to provide the currency to individuals in return for donations to the non-profit organizations; and Step 1207, encouraging the individuals to exchange the currency with the businesses in return for a goods and services.

The reserve bank can issue $DF in coin, paper, and electronic forms.

The initial target conversion value of $DF to $US is envisioned to be 1:1. However, the market for $DF will influence this conversion value. So, the reserve bank will increase or limit supply as necessary to maintain a trading band near a target conversion value.

In one embodiment, issued $DF will have an expiration date or “reuse through” date, to encourage consumers to carry $DF and spend them at participating businesses. It is expected that $DF which are nearing their expiration or “reuse through” date will rapidly lose perceived value, because as the expiration date nears, the opportunity to spend the $DF at a participating business is reduced. To provide real value to $DF nearing their “reuse through” or expiration date, the reserve bank 101 or agent 105, will accept $DF that are past their “reuse through” date in exchange for new $DF, advertising, other services, or $US.

It is expected that a secondary market for $DF trading will develop outside of the $DF reserve bank. There are no current plans to try and regulate this secondary market.

A local market can be anything from a small town in a rural region, to a major metropolitan area encompassing several cities or counties. For the simple reason that most people spend most of their time in the locality in which they live, most charitable activities and most retail commerce is local. However, a single social currency that is accepted across many local markets adds value to the currency by enabling trade in social currency between markets. The methods described herein allow for regulation of the social currency money supply within different local markets, while establishing that the same currency ($DF) can be accepted and exchanged between local markets.

To promote acceptance of $DF in a local market, the reserve bank will partner with local and regional distributors of $DF. Distributors may be agents 105, non-profits 103 businesses 102, or individual consumers 104. Distributors of $DF in a given community might include the Chamber of Commerce, Downtown Development Authority, Community Charitable Fund, civic organizations, schools, private clubs, religious institutions, or philanthropic individuals. The main qualification for being a distributor is the ability to generate demand for $DF, generally by getting local businesses to agree to participate.

No single definition of “local market” is offered, nor is one necessary. Each distributor defines their own area of responsibility as their local market. Thus, depending on the distributor, a “local market” may be the entire state, or it may be only a few blocks in a single city. A given locality (whether defined by neighborhood, zip code, city, county, state, or other geographic or political boundary) may enjoy multiple distributors of $DF that compete cooperatively to increase the adoption and circulation of the $DF social currency within their area of responsibility. An “area of responsibility” may also be delineated by factors other than geography to include specific businesses or organizations selected by the distributor (e.g., the Chamber of Commerce may designate it's “area” or “local market” to include only the paying members of the Chamber.).

Each distributor will be permitted to order and place into circulation an amount of $DF equal to the demand for $DF that they generate, times a multiple. A distributor generates demand for $DF in three ways: 1) by collecting pledges from businesses; 2) by collecting expired $DF (or by buying expired $DF from other business, charities and individuals; or from $DF donated to the distributor); and 3) by providing money ($US) to the reserve bank. The multiple is a function of geographic, demographic, economic and social characteristics of the area of responsibility in which the distributor operates, and represents an attempt to predict and quantify the level of acceptance and circulation of social currency ($DF) in the distributor's area of responsibility. For the purposes of this document and simplicity, the multiple may be assumed to be 1.0; meaning that a distributor may order from the reserve bank a quantity of $DF equal to: (1) the total amount, in $DF, of pledges collected by the distributor (the pledges being documented in a form acceptable to the reserve bank), plus (2) the amount of expired $DF that accompany the order, plus (3) the amount of $US enclosed with the order (or a promise to pay the same at a later date).

The multiple used to fine-tune how many $DF a distributor may order and distribute in a given area, is the result of a formula, algorithm or heuristic to estimate the demand for $DF in the given area, taking into account factors including, but not limited to: the number and density of businesses that accept $DF within the area; the total amount of $DF businesses in the area have pledged to accept; the rate (e.g. $DF per month) at which businesses have pledged to accept $DF; in the absence of an explicit pledge by a business, the rate at which the reserve bank may reasonably expect the business to accept $DF; the marketing and advertising visibility of $DF in the area (including the effort the distributor is willing to expend promoting $DF); the social and economic demographics of the market; the amount that participating businesses advertise their acceptance of $DF; and the quality of the “deals”—the percentage of the purchase price that a typical business is willing to accept in $DF vs. $US. The formula results in a “target” amount of $DF that can be sustained in circulation in a distributor's area of responsibility. That target is compared with the number of $DF actually in circulation in the area (which may be estimated from the number of $DF distributed in the area, minus the number of those $DF that have already expired). The ratio of target circulation to actual circulation results in a multiple that allows more $DF to be distributed in areas where they are in short supply, and fewer $DF to be distributed in areas where they are already common.

Notwithstanding the results of the above computation, the actual amount of $DF that a given distributor may order and issue in their area of responsibility may be modified by agreement between the distributor and the reserve bank.

In one embodiment, distributors advertise their participation through co-branding, ordering custom-printed $DF with their name or logo on the front, along with the logo of the social currency reserve bank. In the electronic version, the distributor's name and/or logo is displayed on screen alongside the reserve bank logo when transactions occur.

Various methods for measuring and regulating the amount of social currency in circulation within a local market are necessary and described here. In the electronic version of $DF, measurement is performed each time a transaction occurs. Each transaction occurs within a computer system that records the spender and the recipient of the $DF being transacted—the $DF are deducted from the spender's account and deposited in the recipient's; the location and time of the transaction, the “deal” (explained elsewhere) being transacted, and other information useful for measuring circulation can also be recorded during the electronic transaction.

When it is desirable to reduce the amount of $DF in circulation in a given area, electronic $DF may be set to expire if not used; or, the cash value of expired or unexpired $DF may be increased, thus encouraging more $DF to be cashed in for $US.

When it is desirable to increase the amount of $DF in circulation in a given area, consumers may be offered additional (or bonus) $DF as a reward for spending the $DF they have; businesses can be offered bonus $DF when they accept $DF from customers; additional $DF may be distributed to the accounts of participating businesses and charities within the local market; the cash value of expired $DF may be reduced (so that a higher proportion of expired $DF are turned in for new $DF rather than being cashed in for $US); or an advertising and marketing campaign may be initiated to increase awareness, adoption and spending of $DF in the area.

Two methods are described that facilitate measurement and control of $DF paper notes in circulation: 1) a bar code or 2D code, and human-readable serial number printed on each note, which the holder of the note is given an incentive to enter into a computer system; and 2) an expiration (or “reuse through”) date printed on each note, along with a cash value for expired notes, that results in expired notes being turned in to the reserve bank where they can be counted.

In the first method of measuring the circulation of paper notes, a bar code or 2D code, as well as a human-readable serial number is printed on each note. The holder of a note may scan the bar code or 2D code with a personal digital device, or type the serial number into a web site. Either action results in the serial number of the note being recorded along with the time, locality, and holder of the note, and perhaps details of a recent transaction or the intended use for the note, if those details are provided by the holder. The holder of a paper note can be given an incentive to perform the scan or entry of the serial number into the computer system by offering the holder desirable information or a valued function. (Examples include: information about where, when, and on whose behalf the note was issued; businesses that have scanned the note; what deal each business is offering in exchange for $DF; entering the holder in a sweepstakes or drawing; or giving the holder the ability to vote for a favorite charity to receive a donation.) Given an incentive, some holders of paper notes will elect to scan or enter the serial number into a computer system, and thus allow the reserve bank to track and measure the circulation of paper notes.

In the second method of measuring and controlling the circulation of paper notes, there is printed on each note an expiration or “reuse through” date, after which the note is no longer usable as a discount coupon by consumers, but is still valuable for other purposes (explained elsewhere). These expired notes ultimately end up in the possession of the reserve bank or local administrative entity, where they can be identified by serial number and counted, and may be removed from circulation as a way to reduce the number of notes in circulation, or may be replaced in circulation by new paper notes or electronic $DF.

To achieve the benefits of a single currency, a single, central reserve bank is established, and a single common brand for the social currency (in this example, “DishFish Dollars”) is used in every local market where the social currency is in circulation. Indeed, one motivation for seeking patent and other intellectual property protection for the method and brand of social currency is to prevent a profusion of different social currencies, thereby helping the social currencies to be stable, well-known and widely accepted, so that the benefits of social currency are more easily realized.

A method of measuring the acceptance of $DF among participating businesses is provided when participating businesses are allowed to advertise on a web site controlled by the reserve bank, the “deal” the business is offering in exchange for the consumer's $DF. A business treats $DF akin to a discount coupon [paper] or redeemable discount points [electronic]. The business may set reasonable conditions on the redemption of $DF by the consumer. These conditions of redemption, and the goods or services available in exchange, are “the deal.” The deal is determined by each business according to their needs, and may be changed from time to time as the business sees fit. The business may be offered the ability to advertise their current “deal” on the same web site(s) where their participation in the program is advertised. The ability to change the deal from time to time is one method the businesses can use to regulate the number of $DF that customers redeem or spend at the business. A better deal should attract more customers and more $DF; a less generous deal will reduce the number of $DF a business will receive from customers. The deals that businesses are offering in a given area is also information that the reserve bank can use to help measure the acceptance, desirability and market penetration of $DF in the area, and decide whether the amount of $DF in the market may be increased, or needs to be reduced

To establish an initial 1-to-1 equivalence between the Social Currency ($DF) and the national currency (e.g. $US), the reserve bank will require participating businesses to offer in exchange for $DF, goods or services of equal or greater retail value in $US. Further, the reserve bank will offer new $DF to businesses, consumers and organizations at a “sell rate” of $1 DF for $1 US, or for an equivalent combination of $US, pledges, unusable or expired $DF, and/or grants provided by the bank to selected organizations. The reserve bank may require that at least part of the above purchase price for new $DF be made in $US. (The reserve bank needs $US to cover the costs of administering the program, to print and distribute $DF notes, and to have $US in reserve so that a cash value can be offered for expired $DF).

In one embodiment, an organization buys $DF from the reserve bank in exchange for a combination of pledges, expired $DF, and some $US, and then “sells” the new $DF to donors in exchange for cash donations (or other value received), at par—$1 US for $1 DF. The organization may also sell $DF below par, for example, $5 US for a sheet of $6 DF, to encourage consumers to buy $DF in a fundraiser. The net revenue in $US the organization can make from the sale of new $DF is equal to the revenue raised in $US minus the cost (in $US) of the $DF sold. Remember that only a part of the cost (1:1 $US for $DF) is paid in $US, and the remainder is paid in expired $DF, pledges and grants. Thus the potential net revenue for the organization from the sale of $DF is equal to the pledges, grants and expired $DF that the organization receives.

The reserve bank will allow market forces, specifically, the donations of participating businesses and consumers, to direct the benefit of $DF to “worthy causes.” A problem exists in that there is wide disagreement, even in small communities, which organizations and causes are worthy of support.

One approach to this problem would be for the reserve bank to establish a set of criteria defining the relative “worthiness” of an organization or cause, based on subjective criteria established by the bank, and permit only organizations that meet those criteria to participate. However, this approach has several adverse consequences. It would require the reserve bank to expend considerable resources vetting applicants; it risks alienating or making enemies of the organizations that the bank deems unworthy. Those organizations and their supporters, would feel hostile to the $DF currency, and would likely boycott $DF, or set up their own alternative social currency, resulting in a multiplicity of social currencies in a community, dividing the community, and giving a bad name to social currencies in general. This could result in the failure of any social currency to take hold. A better approach is to allow individual business owners and consumers to decide the relative worthiness of an organization or cause.

This does not mean the reserve bank abdicates any responsibility to direct the benefit of social currency to socially beneficial organizations. This approach simply accepts the fact that the power of a reserve bank to influence societal and community norms about what causes are “worthy” is severely limited, and that the benefits of a social currency can best be obtained by encouraging all willing persons, organizations and businesses to participate. The reserve bank may influence which causes obtain the greatest benefit by directing grants (a discounted exchange rate) to organizations that support those causes, but the reserve bank would not bar participation by any organization except in extreme circumstances, such as hate groups or other organizations whose purpose or net effect is antisocial or malevolent, and organizations whose participation or affiliation with the reserve bank would embarrass or otherwise discredit the bank or the social currency.

Donors, not the reserve bank, choose the organizations and causes that are “worthy” to benefit from trade in $DF. A local business will only make pledges to organizations the business owner believes are likely to garner the business good will in the eyes of potential customers.

Organizations that are not supported by donations of $DF or pledges will find it difficult to profit from the use of $DF. The cost to buy new, saleable $DF from the bank must be paid for with an equal number of expired or unusable $DF, pledges and/or $US. Thus, to profit from the sale of $DF, organizations will have had to receive significant donations of pledges and/or $DF from consumers and businesses. These organizations that are the beneficiaries of pledges and expired $DF, are thus deemed “worthy causes” by their own communities, not by the reserve bank.

In this donor-centric approach to determining the worthiness of an organization, almost any organization may buy $DF, but most of the buyers will be those organizations that have pledges or expired $DF donated to them by members of their community who thought the organization worthy of support. And while some purchases of $DF may still come from parties that do not meet most people's criteria for a worthy cause, these sales are not necessarily bad. In one embodiment, consumers may purchase $DF directly from the reserve bank at par ($1 US for $1 DF) or at a slight discount. The price they pay in $US for the $DF they purchase will end up funding, in whole or in part, worthy causes; the $US consumers pay to the bank in exchange for $DF increase the cash reserve of the bank; cash that the bank can use to offer a higher buy-back rate for $DF thus increasing the desirability of $DF overall.

Selling $DF to the Reserve Bank

As reusable coupons, $DF lose apparent value as they come closer to their expiration or “reuse through” date, unless they also have a value for some other purpose after that date. Their value, post expiration, is provided by the reserve bank, in three ways:

The reserve bank may offer to buy back $DF for a “buy rate” of less than $1 US for $1 DF—perhaps significantly less—and may limit buy-backs only to expired $DF. The reserve bank could offer a variable buy-back rate, paying more for $DF that are closer to their expiration date. But in practice, it is sufficient for the reserve bank to limit buy-backs only to $DF that have expired, and allow the free market to assign a value to $DF that are nearing expiration (similar to US Savings Bonds, which can be redeemed for face value only after they have reached maturity, but which may be sold for less than face value prior to maturity).

The reserve bank will accept expired $DF at par in exchange for new $DF, as discussed in the paragraphs above, “Buying $DF from the reserve bank.” (In the paper model, a small printing/shipping fee in $US may be assessed to cover those costs, in addition to the $DF.)

The reserve bank, being the agency in control of printing new $DF (in the paper model) or issuing new $DF for exchange via electronic devices (in the mobile web model), is able to sell advertising on $DF, either as printed ads on the backs of paper $DF, or ads displayed on-screen during the exchange of electronic $DF. The reserve bank may accept expired $DF as payment for that advertising.

Advertising with $DF

In the paper model, the front side of $DF is printed, while the back side is reserved for advertising. When the paper $DF is printed, the back may be left blank, or it may contain a pre-printed ad paid for by a business, organization or other party. In either case, blank or pre-printed, the back of the $DF provides an opportunity for any business (or other party) that accepts a $DF to advertise. The recipient of a paper $DF can stamp or print an ad for their business, organization or cause on the back of the $DF before placing the $DF back in circulation. Even if there is already an ad on the back, the party who accepts a $DF can apply a sticker to the back on top or alongside the previous ad. In the electronic model, the recipient of a $DF will have the option to purchase “advertising impressions” to display an ad of their choice whenever $DF are exchanged. (Advertising impressions can also be delivered to consumers whenever they visit the web site of the reserve bank for any reason, such as to find participating businesses). A business may pay for advertising impressions with expired $DF, $US, or a combination of both.

The “reuse through” date serves to limit the time that advertisers are required to participate. One of the benefits of encouraging businesses to advertise on $DF, is that so long as they have an ad saying that they accept $DF, they are under some obligation to continue to participate in the program. Yet no business wants to be tied into participating indefinitely. Paper $DF have a “reuse through” date, after which they begin to leave circulation at an accelerated pace. This allows businesses that advertise on the backs of paper $DF to end their participation after the reuse through date of the last $DF they advertised upon has passed. A business that advertises on electronic $DF and who are not burdened by physical $DF circulating with their ad may cancel their ads online and withdraw from participation at any time.

It is expected that donors and businesses will donate expired $DF to non-profit organizations. The non-profit organizations will then submit the expired $DF to the reserve bank in return for new $DF or for their cash value.

Reserve bank operations can be funded with transaction fees in $US that are charged to non-profit organizations for the processing of pledges, expired $DF, damaged $DF, and unwanted $DF. Additionally, the reserve bank's operations can be funded by at least four revenue streams: the difference between the buy rate and the sell rate; the loss ratio (some $DF—especially in the paper model—will be lost and therefore never have to be bought back); advertising paid for in $DF (which then likewise will never have to be bought back); and interest earned on the money held in reserve.

In certain embodiments, businesses re-use $DF in the role of consumer, or use $DF for promotional purposes. For example, the business could offer $DF as a rebate for a purchase, spend the $DF at another business, provide $DF as a gift, provide $DF as an employee reward, provide $DF as a customer incentive, or the like.

### Secondary Embodiments of the Invention

The following section, “secondary embodiments of the invention” provides additional details regarding the invention and its potential embodiments. The section is incorporated into the disclosure to the extent that it does not conflict with the information which has been provided in earlier sections.

### INTRODUCTION

This document describes a Social Currency (referred to as “DishFish Dollars” or $DF) as a solution to problems facing charitable organizations, local retail businesses, and consumers. We describe methods whereby social currency can be used as money to trade for things of economic value; used by charities to encourage donations; used by retail businesses to attract customers; and used by consumers to save money.

This document describes a Social Currency (referred to as “DishFish Dollars” or $DF) as a solution to problems facing charitable organizations, local retail businesses, and consumers. We describe methods whereby social currency can be used as money to trade for things of economic value; used by charities to encourage donations; used by retail businesses to attract customers; and used by consumers to save money.

In various embodiments, $DF are used as a medium of exchange (an alternative currency) between charities and other organizations; exchanged between merchants and consumers for goods and services; sold by charities like fundraising coupons to be “spent” by consumers at participating retailers; given to valued customers by retail businesses as loyalty rewards, to encourage repeat business; advertised on by participating businesses; given as gift certificates; or donated to charities.

Agreements with local retailers (“merchants”) and community organizations (“charities”) give the DishFish Dollars real value in the commercial economy. Merchants agree to accept $DF as full or partial payment for goods and services; charities distribute $DF to reward donors or sell $DF to the public to raise funds; consumers with $DF seek out participating merchants to spend their $DF.

Entities and methods in FIG. 1: Charity—(103) A person, group, business or organization to which donors are willing to contribute something of value. As used herein, a charity is defined broadly to include any organization or cause that members of a community deem worthy of support: the parents of a sick child, the independent bookstore whose continued viability is important to the community, or any endeavor that persons will voluntarily donate value to, are charities. Also used interchangeably: cause, good cause, or worthy cause.

Donor—(104) An individual, business, or organization that contributes something of value to a charity. Donors are also consumers (104), although not all consumers are donors.

Merchant—(102—also Business, Retailer) Any party (individual, business or organization) engaged in the sale of goods or services, that is willing to accept $DF as full or partial payment for those goods or services. Provides goods or services to consumers in exchange for money or other value.

Tacit deal between local merchants and charities: donations for customers. Made explicit, it's called Charitable Advertising.

Consumer—(104—also Customer) Any party (individual, business or organization) that uses $DF to help pay for goods or services from a Merchant.

Agent—(105) An individual, business or organization that has knowledge of and contacts with charities and merchants in a specified area of responsibility (a geographic area or vertical market in which the agent has knowledge and contacts). The agent acts on behalf of, or as an intermediary for, the reserve bank. Agents may: determine the authenticity and eligibility of charities and merchants; ensure merchants and charities operate within the policies outlined by the reserve bank; aggregate and make a market in pledges so that $DF can be ordered and distributed in economic quantities; buy $DF from the reserve bank for distribution to merchants and charities; be licensed to print their own $DF; be licensed to white-label $DF with their own brand; sell advertising on $DF; and sell or distribute $DF to merchants, charities and consumers to raise revenue or to accomplish other purposes.

Reserve bank—(101) A single, central entity that prints, tracks and issues $DF. The reserve bank may have a reserve account of economic currency (e.g. $US) that it may use to buy $DF at prices, places and times set by the reserve bank to control the number of $DF in circulation, and to impart value to $DF that have expired or are no longer usable.

Pledge—a documented promise by a merchant to accept $DF from consumers as full or partial payment for goods and services. A pledge may have a specified term during which it is in effect, it may continue indefinitely, or it may end when the merchant ceases to participate. A pledge may specify a quantity of $DF the merchant agrees to accept, or a quantity per unit time (e.g. $DF per month), or the quantity may be unspecified. A pledge may or may not include a commitment to donate a certain quantity of $DF to a charity. A pledge may be given on behalf of a specific charity (allowing the charity to use that pledge to purchase $DF from the reserve bank or an Agent at a lower price), or the pledge may be on behalf of no specific charity, but made by the merchant to obtain the benefits of having pledged.

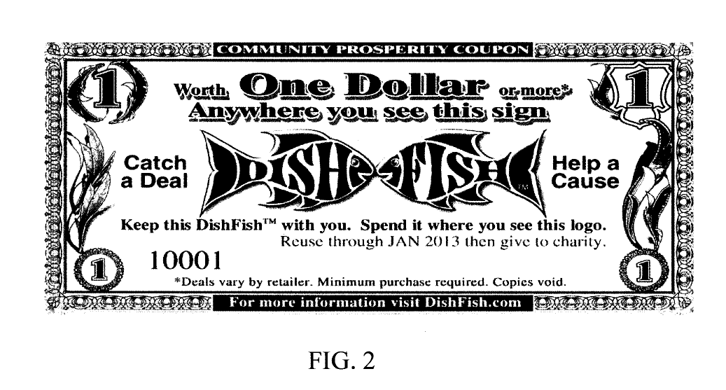

Terms Used in FIG. 2

The “redeem by” (or equivalently, “redeem through,” “redeem until,” “reuse through” etc.) date, expressed on the DishFish Dollar in FIG. 2 as “Reuse through JAN 2013 then give to charity,” is the date through which a dated piece of currency may be redeemed (exchanged for goods and services) at participating businesses; also the date through which any offers or discounts advertised on the currency are valid; and also the date through which any business advertised on the currency is required to participate. In other words, after the redeem by date, the piece of currency may be refused by a participating business, and any representation made by a business on any piece of currency that has passed its redeem by date may be considered null and void at the option of the business. In this application, and in practice, this date may also be referred to using the more common term “expiration date,” but that does not imply that the currency is of no use for any purpose after that date, only that its use may be restricted as described herein.

Other terms used in this document.

Value—anything of value that may be given or received, including but not limited to: material goods; services; labor (whether paid or volunteered); capital (equipment); money, debt, credit, equity instruments or derivatives; and pledges.

Money is a token for the exchange of value. Money is an old invention that largely displaced barter as the primary means of exchanging value, simplifying trade and resulting in an economy able to create more wealth than an economy based only on non-monetary methods of exchange such as barter, sharing and giving.

Currency is a physical or virtual manifestation of money, denominated in units, identified by a brand (e.g. “U.S. Dollars”, “Euros”, and in this context, “DishFish Dollars”), which have associated methods called transactions, whereby ownership of the currency is transferred between persons, usually in exchange for something of value.

Social goods are activities that have demonstrable value to society, even economic value, but which are problematic to trade or invest in. For example, the local center for at-risk youth, which keeps kids off the street, reduces crime and produces productive, responsible young adults, obviously provides enormous economic value to the local economy, but it's not value that the center can sell to businesses or to consumers, nor is it a value that people can invest in for monetary return; it is a social good. The economic return-on-investment from social good is spread out across a community or a society, making the economic value difficult or impossible to capture and return to those who would invest in it. So whereas economic goods can be exchanged for money, social goods cannot. Organizations that provide social good (charities) cannot raise revenue through the sale of their goods, and are unable to provide a return-on-investment to would-be investors. Instead, charities must rely on governments, non-governmental organizations (NGO's) and enlightened individuals to provide the investment and the revenue they need to operate. What DishFish Dollars provides is a formal social currency that works in parallel with economic currency to facilitate the exchange of, or investment in, social goods, a medium of exchange comparable to money to supplement barter, sharing and giving as methods of exchange in the social realm.

DishFish Dollars ($DF)

The social currency described herein, branded “DishFish Dollars” ($DF), provide value to charities, merchants and consumers.

Value to charities. Charities can use $DF to: reward donors and volunteers; sell $DF to raise $US; use $DF as a medium of exchange between charities.

Value to merchants. $DF provide a token of value for a flexible and low-cost incentive program to attract customers and get them to buy what the merchant wants them to buy. In addition, $DF provide opportunities to advertise; a way to reward employees; a way to encourage good customers to return; and a way to support favorite charities.

Value to consumers. $DF act as discount coupons good at any participating merchant. $DF give consumers a way to donate to a favorite charity without sacrificing spending power. The consumer can donate a dollar to a favorite charity in exchange for a DishFish Dollar, and spending the $DF at a merchant to save a dollar off their purchase. $DF may increase a consumer's buying power when purchased at a discount, for example, if the consumer buys a sheet of six $DF for $5 US, the consumer's buying power is increased 20%.

Local merchants provide a social good. Despite trends towards online purchases, most spending remains local. People live locally, buy locally, and give locally. Local businesses provide jobs and offer things to do in a community. Local retailers return much of their revenue to the local economy, whereas “big box” stores and chains send much of their revenue out of the local or regional economy, or out of the country entirely.

DishFish helps local merchants compete for socially conscious customers. Big retail businesses have IT departments and infrastructure that allows them to create brand-specific fundraising scrip and loyalty rewards programs that socially conscious consumers can use to benefit their favorite charity. This gives big retailers a competitive advantage in attracting socially conscious consumers. $DF gives local merchants a charitable rewards program they can use to compete with the big retailers in attracting socially conscious customers.

DishFish helps donors afford to donate more; encourage more people to become donors.

Donors typically expect little in return besides recognition and thanks, but with the invention of social currency, donors can be paid for their contribution, at least in part, with social currency. In the absence of social currency, donors get little or nothing in return for their contribution. This places a natural limit on contributions because few can afford to give much without something in return. The limits are greatest in poor societies (exactly where charities are needed most) because donors in poor societies are on average less able to afford the sacrifice that donation entails. If donor could be given something of value in return, more people could afford to be donors, and donors could afford to give more.

If there existed a viable and widely-used social currency—operating in parallel with the economic currency but designed for the trade of social goods rather than economic goods—and which included methods whereby the social currency could be traded for things of economic value, charities would be more able to raise money and value, and participate more fully in the economy. Donors could be paid for their donations in social currency, could afford to donate more, investment in social good would increase, and the benefits to the society would also increase, as wealth is created by putting to work the excess capacity available from local merchants to produce consumer goods and services.

Generation of wealth through real-time advertising of excess capacity. Merchants (and other consumer-level economic activities) often operate with excess capacity (empty seats, unsold surplus goods, service providers sitting idle . . . ) which can be turned into value if customers can be drawn to the merchant at the time the surplus exists, and given an incentive to buy the goods and services that are available due to the excess capacity. $DF can help bring donors to merchants with excess capacity, and allow the merchant to specifically discount the excess capacity he has available at any given moment, through the “DishFish Deal.”

Merchants may also be donors, but they are a special case of donor. Like any donor, a merchant can offer money or time, but a merchant can also donate the goods or services in which they trade. This is often a better option for the merchant than donating time or money, because merchants frequently have surplus goods or services which will either go to waste or have to be sold at a discount—goods and services which they would be willing to donate to a charity. But a charity with no present need for those goods or services, and unable to barter or sell them, is unable to benefit from the donation.

In the current state of the art, the merchant donates to the charity some coupons or gift certificates for the surplus items, which the charity can sell or auction to supporters. But that takes time, and by the time the supporter comes to the merchant with a coupon, the surplus may be gone. (The item may still be available, but if it is no longer surplus, it could be sold for full price, so the cost of the coupon to the merchant ends up being more than the merchant intended.)

What is needed instead is a flexible coupon that can be redeemed for whatever is surplus at the time the coupon is presented to the merchant.

Elements of a social currency and associated methods of exchange
1. Pledges
   A. Currency
   B. Single currency, many localities
   C. Branding—“$DF” for the purposes of this document
   D. Printed and regulated by reserve bank
   E. Issued by Charity
   F. Backed by Merchant
   G. Spent by Consumer
   H. Physical embodiment—paper coupons
   I. Electronic embodiment—individual accounts accessible by electronic device
   J. Social Currency as Discount Coupon
   K. Social Currency as medium of exchange between charities
2. Charitable Advertising
   A. Examples and prior art
   B. Advertising on currency (prior art—fundraising coupons)
   C. Advertiser-supported transactions
      1. Source of revenue to cover costs of $DF
      2. Lock-in for merchants

### Embodiments of the Exchange of Social Currency

1. Initial distribution $DF in a community (FIG. 1)
   A. Prerequisite is having merchants willing to accept social currency as partial payment for goods and services, in light of the benefits they receive for participating.
   B. Merchants make pledges to favorite charities in exchange for promise of advertising and promotion that will attract more customers.
   C. In some embodiments, a regional agent (105) collects pledges from charities in exchange for promise of $DF. In other embodiments, charity (103) deals directly with reserve bank (101).
   D. Agent (105) or charity (103) orders $DF from reserve bank. (Pledges+$US→reserve bank→$DF).
   E. Agent (105) gives $DF to charities in exchange for pledges; may sell remaining $DF to public recoup $US spent.
   F. Charities sell or distribute $DF to donors; donors then assume the role of consumers and/or merchants depending who they are.
2. The big cycle (FIG. 4)
   A. Consumer gives $DF+$US to Merchant for discounted goods/services
   B. Merchant accepts the $DF as payment; advertises on back of $DF (paper embodiment) or earns an advertising credit (electronic embodiment), and then either spends the $DF (becoming a consumer), or: gives $DF to employee, customer or supplier (who then become consumers); or donates $DF to charity (perhaps in fulfillment of pledge)
   C. Charity resells or redistributes $DF, completing the cycle, and providing circulation for ads of Merchants who have placed ads on $DF
3. Other cycles
   A. Expired $DF (+$US) used by charities or merchants to buy new $DF
   B. Charity A gives $DF to Charity B in exchange for value (social currency)
   C. Consumer A buys $DF, and gives $DF as gift to Consumer B
   D. Merchant gives $DF (+Ad) to Employee
   E. Merchant gives $DF (+Ad) to Customer
   F. Merchant or Charity gives pledge plus $US and/or $DF to get new $DF (which may have pre-printed ads for the merchant that made the pledge)
4. Physical and Electronic Embodiments
   A. Interchangeable physical→electronic→physical
   B. The electronic social currency
      1. Form
      2. Transaction
      3. Advertising
   C. The physical social currency
      1. Form
      2. Transaction
      3. Advertising
      4. “Reuse through” date (wear out; ad expiry; counterfeit discouragement; spend encouragement; change of value as “reuse through” date nears).
      5. Value after “reuse through” date (pay for advertising; give to charity to fulfill pledge; pay for new $DF; exchange for cash value).
      6. Novel means for tracking paper currency and detecting/preventing counterfeits.

The last item, above, “Novel means for tracking paper currency and detecting/preventing counterfeits”, is detailed below:

In addition to a unique serial number, a paper $DF may include another unique number, called a tracking code, which differs from the serial number in the following ways:
1. Serial numbers are usually sequential, and easy to guess; tracking codes are non-sequential, pseudo-randomly generated numbers or alphanumeric strings with billions (or more) possible combinations, of which very few are actual tracking codes associated with a particular $DF. (In computer parlance, they are keys that hash into a large namespace, with few hits.)
2. The serial number is human-readable. A tracking code may be human readable but is also machine-readable (for example, encoded in a QR code) to facilitate quick scanning and entry into a computer database system.

Tracking codes are not new. But the methods described here to use a tracking code imprinted on paper coupons as a way to track and validate the coupon, and to interact with the holder of the coupon, is claimed to be novel and not obvious.

The most likely embodiment of a tracking code on a paper $DF would be to encode it in a QR code (google it) printed on the front or back of the coupon. This would allow consumers, merchants and others to scan the QR-encoded tracking code, using common and readily available software (“apps”) and handheld electronic devices (“smartphones”).

The consumer would be incentivized to scan the code by words surrounding the code, for example: “Scan to vote for your favorite charity or merchant, and to validate coupon” or “scan to enter a sweepstakes.”

Merchants would have an incentive to scan a coupon to check that it is valid (and not a likely counterfeit, copy or forgery) because merchants are accepting the coupon as full or partial payment for goods or services. The merchant may also be given other incentives, such as: scanning the tracking code as a way to prove they are fulfilling a pledge to accept a certain number of coupons in a certain period of time; scanning a tracking code to earn advertising credits; scanning a tracking code to deposit an expired or unusable paper coupon into an electronic account (converting the paper embodiment into an electronic embodiment of the social currency)

In one embodiment, the holder of the paper coupon will scan the QR code with a third-party QR code scanning app. The QR code encodes a URL (web address) ending in the tracking code (e.g. “http://dishfish.com/qr/{unique tracking code goes here}”). This action opens a web page in a mobile browser on the holder's smartphone, and in the process sends the tracking code to a computer system (the back-end database at dishfish.com, in this example). The scan of the tracking code is recorded in the computer database system, along with all other details available from the scanning device and software, such as: the tracking code and the time it was scanned; the physical location of the smartphone; identifying information for the holder (which may include the device's cell phone number, or the DishFish login/username of the holder); the IP address of the smartphone, and any cookies that might previously exist for the domain (dishfish.com) in the browser's cookie cache.

Now there are two possible embodiments of tracking codes in QR codes. Method 1 is where the tracking code is unique to the coupon. Method 2 is where the tracking code is unique to an Advertising Sticker that merchants affix to the coupon. Both methods may work in tandem, for example, by printing the coupon's unique QR code on the front face of the coupon, while merchants affix their Advertising Stickers to the back of the coupons. Or, the merchant may affix the Advertising Sticker over the top of the coupon's preprinted QR code.

METHOD 1: Someone (the “holder”) use their smartphone to scan the QR code containing the coupon's tracking code. The computer system then looks up the tracking code. There are two possibilities: 1) the code exists in the system, associated with a coupon legitimately printed and distributed by the reserve bank or its agents; or 2) it is an unknown code, or one that has been encountered previously but is not associated with a legitimate coupon. (Because the tracking code maps into a large name-space, virtually all random or “guessed” codes will fall into this latter category.)

If the code is not associated with a known coupon, there are several possibilities: possibly an error was made in transmission; a brute force attempt to garner data from the system is being attempted; or a random tracking code has been printed on a counterfeit coupon. The scan will be recorded, and the holder will be presented a web page telling them that this is not a valid coupon, advising them to scan it again, and perhaps giving them information about what to do with the counterfeit, or asking them to fill out a form giving details of where they got it. After a limited number of retries (a defense against brute force attacks), the holder's device (identified by cookie, phone number, username or IP address) is temporarily locked out of the system.

If the code is associated with a known coupon, the scan details are recorded, and compared against the record of previous scans. This is a method to identify copies: every scan is associated with a time and a location. The distance between one time-location pair, and the next time-location pair, results in a velocity. (For a physical coupon to travel from point A at time X, to point B at time Y, it must have, in the intervening time from X until Y, traveled in a direction at a certain speed—direction plus speed is velocity.) Since each physical coupon has a unique code (unless the coupon has been copied), and since there are practical limits to the speed at which a coupon may travel, then it is possible to apply both logical and statistical tests against the record of a coupon's scans, to determine if there are multiple copies of that coupon in circulation. A coupon that is much copied will be scanned in more places, more widely separated, than a coupon of which only one is in circulation. And on occasion, when two different copies bearing the same code are scanned at distant locations within a short period of time, the velocity between those two scans will be very fast. When the velocity passes a certain threshhold, and/or the pattern of scans appears (using statistical methods) to be unusual or indicative of a code that has been copied, the coupon(s) bearing that code are flagged as possible copies, and a holder (especially a merchant) scanning that code can be advised that the coupon has likely been duplicated.

METHOD 2: As an alternative, or possibly a supplemental, embodiment to the above, merchants are provided with Advertising stickers—self-adhesive labels on which are printed an ad for the merchant and a QR code. The QR code here contains a tracking code that is unique to each Advertising Sticker, allowing it to double as a Tracking Sticker. When a merchant receives a $DF from a customer, before putting the $DF back in circulation, the merchant affixes an Advertising Sticker to the back of the $DF. When someone scans the QR code, unless they are logged in as a merchant, they will see an ad for the merchant on their smartphone's browser. (The ad may display the merchant's current “DishFish Deal,” directions to the merchant's storefront, reviews for the merchant, the merchants operating hours, phone number, etc.) The scan is also recorded, but instead of just establishing a “velocity” for the coupon, as the previous method describes, the scan also records a scan of an advertising sticker for the merchant that most recently accepted that coupon. Recorded in the database is the fact that the merchant has affixed the sticker to something that is now in circulation.

The model here is significantly different than the model in which the reserve bank issues, tracks and validates coupons. In this model, the merchant participates in validating the $DF coupon when he affixes his sticker to what he believes is a genuine $DF. A velocity can be inferred from subsequent scans of the same sticker, and the techniques described in the previous method can be applied to detect copies of the Advertising Sticker. Note that when the next merchant affixes his sticker to the back, he will likely cover the previous merchant's sticker. That will make the scan trail of the previous sticker stop, and a new scan trail begin. So in this method, the complete path of a given $DF coupon is lost unless the user who scans the QR code is also prompted for the serial number of the $DF coupon, but we are able to track the usage of Advertising Stickers (and thus also count advertising impressions) while still tracking coupons that have been “validated” by the fact that they have been accepted by a merchant. As a result, responsibility for tracking and prevention of counterfeits is now shared between the reserve bank and the merchant. In effect, the merchant directly issues the currency, not the reserve bank, because by affixing and placing his Advertising Sticker in circulation, the merchant is validating a coupon (or something that passes for a coupon) by physical examination. The coupons that have stickers applied to them are eventually turned in to the reserve bank or an agent in exchange for new coupons, and at that time, the reserve bank or agent can make a determination if the coupon to which the sticker is attached is genuine or a counterfeit, and either give credit for it, or not. The reserve bank or agent would lean heavily towards honoring any form of $DF coupon that a merchant felt was worthy of applying a validation sticker to.

END OF SECTION TITLED: “SECONDARY EMBODIMENTS OF THE INVENTION”

DishFish Overview

The following section, “DishFish Overview” provides additional details regarding the invention and its potential embodiments. The section is incorporated into the disclosure to the extent that it does not conflict with the information which has been provided in earlier sections.

Community Prosperity Coupons—“Catch a Deal, Help a Cause”

DishFish Dollars ($DF) are reusable fundraising coupons that save money for consumers, bring customers to local merchants and raise funds for community organizations.

Buy, Spend, Repeat

Local organizations sell $DF to raise funds. People buy $DF to save a dollar at participating merchants. But unlike most fundraising coupons, DishFish Dollars are good at any participating merchant; and unlike coupons you use once and throw away, DishFish Dollars are reusable, which is good for the environment and especially attractive to merchants. Merchants that accept $DF can reuse them in a number of ways. They can spend $DF elsewhere; reward valued employees with DishFish Dollars; use $DF as customer incentives; or donate $DF to a favorite organization to sell again.

Benefits for Merchants
1. Free: Merchants pay no fee to participate, and may end their participation at any time
2. Flexible: Merchants can offer any deal they like, and may change the deal at any time
3. Low cost: Merchants can recoup the cost of the discount by reusing $DF in a number of ways
4. Free Ads: Merchants can advertise on every $DF they receive, and get free online advertising
5. Goodwill: Merchants that accept $DF attract socially conscious customers
6. Good deed: Accepting $DF makes it possible for local charities to sell $DF to raise funds.

FIG. 2: One DishFish (front). Serial number and sponsor logos not shown. The back bears the names and locations of participating merchants, or an advertising sticker affixed by the last merchant that accepted it.

Benefits for Charities and Community Organizations
1. Easy fundraising: Buy $DF. Sell them to staff, volunteers, supporters and the public.
2. High margin: Keep up to 92% of the sale price.
3. Continuing income: Sell $DF year round. Resell to the same supporters over and over.
4. Great way to say “thank you”: Use $DF to thank staff, donors and volunteers. $DF are inexpensive gifts with real value to their recipients.

Benefits for Consumers
1. More money to spend: Buy six $DF for $5—increase your buying power by 20%!.
2. No more dilemma between giving and spending: Want to give more, but need the money? Buy DishFish Dollars from your church or charity. Your money works for them and you get more to spend.
3. Good lots of places: Carry $DF like cash to spend wherever you see a DishFish logo.
4. Supports local businesses: If you've been shopping at the big-box stores to save a buck, now you don't have to. DishFish gives you more money to spend, and you can spend it locally.

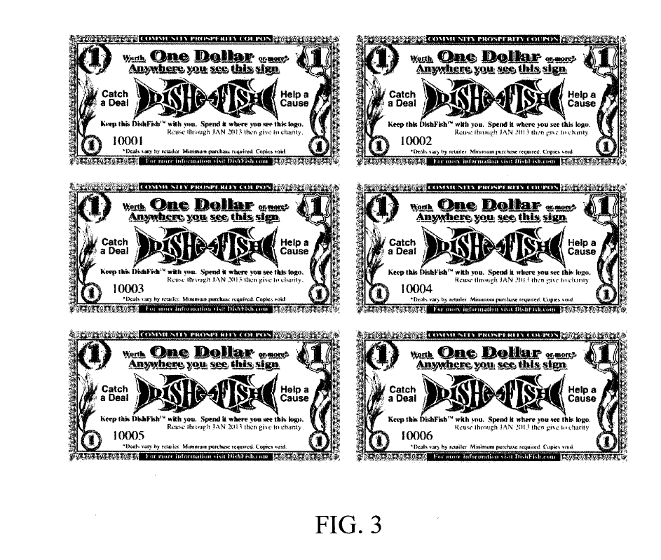

FIG. 3: Sheet of Six, $1 Coupons

$DF are produced and sold in sheets of six, one-dollar denominated coupons, perforated for easy separation.

Ads on the back: The backs of $DF carry ads for participating merchants. The ads may be preprinted, or the last merchant to accept a $DF may put an ad sticker on the back, before sending the $DF back into circulation.

Like advertising on a dollar bill: $DF may carry ads for participating merchants, but unlike most discount coupons, all $DF are good at every participating business, not just at the advertised one. Imagine if you found an advertising sticker on a dollar bill—you wouldn't have to spend that dollar at the place advertised on the sticker; you could still spend it at any merchant that accepts dollar bills. We made $DF good at any participating merchant, too, and as a result, consumers don't leave them in a drawer like other coupons. Instead, consumers carry $DF like cash. Every time they open their wallet, the consumer sees their $DF, and are reminded to look for places that accept DishFish Dollars . . . including the advertised merchant.

Merchants offer a “DishFish Deal” of their choice: Merchants redeem $DF from customers in exchange for a “deal” that serves the merchant's interests, and which the merchant may change as needed. The “DishFish Deal” can be a simple discount (“Spend $10 and get $1 off your bill”), extra goods or services (“Make your double a triple”), or specific items (“Get an 8 ounce bottle of shampoo with a haircut”—this is a great way to move overstock items). Merchants who have $DF to spare can turn the deal around and offer DishFish Dollars to customers incentive (“Order today's special, and get a DishFish Dollar to use on your next visit”).

Merchants can get more or fewer $DF by changing the deal: A merchant can influence how many $DF they receive, and how many DishFish customers they attract, by changing the deal to make it more or less attractive. The merchant can change the deal as often as necessary: hourly, daily, weekly, or in response to changing conditions such as oversupply or undersupply of an item, or the number of customers in the store. And if the merchant finds himself with too many $DF, he can put them to good use by offering them to customers as an incentive to buy what the merchant wants to sell that day, or as an incentive to come back. If the merchant still has too many $DF, he can sell them, cash them in, or donate them to a favorite charity.

Participation is free and easy for merchants: Any merchant may put up a sign saying “DishFish Dollars Accepted Here,” or tape a DishFish Dollar in their window or on their cash register, to attract socially conscious consumers. If the merchant registers at DishFish.com, their business will be listed on DishFish.com so DishFish customers can find them. Registered merchants may use the DishFish logo in all their advertising. There's no commitment or minimum time for participating; a merchant may quit at any time. (With the exception that if a merchant chooses to place an ad on the back of DishFish Dollars, the merchant must accept $DF until the $DF bearing the merchant's ad are past their “reuse through” date.)

Charitable Advertising: Merchants that pledge to accept $DF for at least 3 months can help their favorite organization raise funds. For each merchant that pledges, an organization may buy 25 sheets of DishFish Dollars at $1 (or less) per sheet. By selling $DF to the public for $5 or $6 a sheet, the organization can make over $100.

DishFish Dollars remain valuable even after their “reuse through” date: DishFish Dollars are worth a dollar off at participating merchants until passing the “reuse through” date printed on the front of the $DF. After that, the bearer is encouraged to donate the $DF “to charity.” These “old $DF” are still worth a dollar each when used to buy sheets of fresh, new $DF. (And if they don't want new $DF, they can sell the old $DF to an organization or merchants that does.)

TABLE 1
Price of new DishFish Dollars

| Buyer | Price per sheet of 6 $DF | Min. order | Notes |
|---|---|---|---|
| Consumers¹ | $5 per sheet, or $1 per coupon | 5 sheets | No minimum when |
| | | (online) | purchased locally. |
| Merchants² | $4 per sheet, or $2US + $4DF per | 10 sheets | Includes merchant's ad on |
| | sheet. (Net cost: $20 to $40 for 10 | | the black of each coupon. |
| | sheets) | | |
| Pledge | $1 per sheet, or $0.48 + 6DF per sheet | 25 sheets | Organizations that get |
| recipients³ | | | pledges from merchants. |
| Bulk sales | $6 per sheet, up to 5 of which may be | 100 sheets | May be limited to |
| | $DF past their “recuse through” date. | | localities where the |
| | (Net cost in $US: $1 per sheet) | | demand for $DF is greater |
| | | | than the supply. |

Note 1: For $5, consumers get a sheet of 6 $DF, increasing their buying power by 20%. Consumers may order $DF online but will typically buy $DF from a local charity or merchant. Consumers may also receive $DF as gifts from other consumers; from nonprofit organizations that give their supporters or volunteers $DF; or from merchants, as promotional items or loyalty rewards.

Note 2: This price is available to registered merchants who accept $DF from customers. Merchants can buy sheets of $DF for $4 per sheet (or $2 plus 4 old $DF per sheet). The merchant can then sell or give $DF to customers who want to the DishFish Deal but don't have $DF. (The customer might buy a sheet of six $DF, give one or more to the merchant to get the deal, and keep the rest to use on future visits.) A merchant may also sell $DF at their place of business to raise money for a favorite charity or organization. Merchants may have an ad for their business pre-printed on $DF at no additional charge. Note that a merchant must continue to accept $DF until after the “reuse through” date on any $DF bearing the merchant's ad; to allow merchants to limit this commitment, a merchant may specify the “reuse through” date on $DF they order, from as much as 12 months to as little as one month from the date of issue.

Note 3: Merchants may fill out a pledge form on behalf of an organization, promising to accept from customers an average of 50 $DF per month for 3 months. For each pledge, the organization may buy 25 sheets of DishFish Dollars at $1 per sheet (or, if the organization has collected enough old $DF, for 48 cents plus six old $DF per sheet). The organization can then sell those 25 sheets—150 DishFish Dollars—to consumers for $5 per sheet or $1 per coupon, netting $100 to $138 from each pledge. To be eligible to buy at this price, an organization must have acquired pledges from at least four separate, independently owned and unrelated merchants, and must have been verified as a qualifying charitable organization or worthy cause by the reserve bank or a regional agent. (See Appendix B).

END OF SECTION TITLED: “DISHFISH OVERVIEW”

Rewards Methods

The following section, “REWARDS METHODS” provides additional details regarding the invention and its potential embodiments. The section is incorporated into the disclosure to the extent that it does not conflict with the information which has been provided in earlier sections.

A centralized, points-based consumer loyalty rewards system, in which points are exchanged using commonly available, mobile network-connected, camera-equipped devices (referred to in this document as “smartphone,” “device,” or “mobile device”) as optical readers, and where the points are purchased using economic currency and/or social currency.

Prior Art: In a loyalty rewards system, a customer makes a qualifying purchase and is awarded “points.” These points accumulate in an account (or on a physical representation of an account such as a punch card). The customer later redeems these points for cash or other rewards. Examples include frequent-flyer programs, credit-card “percentage back” programs, and merchant-specific cards where the customer typically buys from a merchant x times to get an item free.

Problems with prior art:
1. Different rewards programs means a consumer must keep track of many different accounts. Where the rewards system is integrated with a merchant's point-of-sale system, the consumer is asked to present a token, usually in the form of a plastic card or keychain tag, on which there is a magnetic stripe or optical code that is read by a device to identify the customer's account. Because each merchant has their own separate point system, consumers are burdened with having to carry many different tokens, if they want to take advantage of the loyalty programs at all the retailers they visit.
2. The points in different accounts are seldom interchangeable or transferrable between systems. (Exceptions exists, such as in airline alliances where points may be earned on one airline and redeemed on another. But the typical merchant rewards account has no such feature.)
3. Points are not generally transferable to other parties (exceptions exist, but seldom in the case of small merchant accounts).
4. Rewards systems at brick-and-mortar merchants are often costly add-ons to a commercial point-of-sale system. An example is a “Flock Card”, which is currently used at Espresso Royale Café in Ann Arbor, Mich. This places a burden on the merchant, especially smaller merchants, putting them at a competitive disadvantage to larger retailers who can better bear the cost of the system due to economies of scale.

Solutions offered by this method:
1. The customer needs only a single rewards account, and therefore only one token (card). The one token is good at all participating merchants.
2. Points may be interchanged at the discretion of the merchant (that is, a merchant may opt to accept a competitors' reward points).
3. Points may be donated to charity, and/or sold by charities to participating merchants.
4. The system uses common smartphones as readers. No expensive equipment is needed, and the system is independent of the merchant's point of sale system, and thus requires no expensive add-ons or integration. It is easy and inexpensive for even the smallest merchant to adopt this rewards system.

Social Currency—Social Rewards Points

A defining characteristic of social currency is that it benefits businesses, charities and other organizations whose existence or activities create social good, and does so in situations where the exchange of economic currency would be impractical. As a social-currency-based rewards system, charities are involved this point system.

Charities raise funds by issuing or selling points to merchants and, in some embodiments, also sell points to consumers and other charities. Charities raise funds by purchasing points from a reserve bank at a discount; the charity may then sell those points at a price determined (in some embodiments) by the charity, or (in other embodiments) at a retail price set by the reserve bank. In some embodiments, the reserve bank sells points directly to merchants, and gives a part of the proceeds to a charity designated by the merchant. Merchants and consumers may donate points to a charity, and the charity may, in turn, sell those points, or cash them in by selling them back to the reserve bank in exchange for economic currency (e.g. $US) or social currency (e.g. $DF). In certain embodiments, points expire after some period of time if not used. In most embodiments, when a customer redeems points for an award, the points are subtracted from the customer's account and deposited in the account of a charity or charities designated by the customer and/or merchant.

Merchants must buy points from charities (or from the reserve bank to benefit a charity), so that the merchant has points to award to customers. In some embodiments, these points are purchased by the merchant in advance, and in other embodiments, the points are purchased as they are awarded to customers. (The reserve bank may offer the merchant credit, giving the merchant points to award to customers and billing the merchant for the points later.) In some embodiments, the reserve bank may offer a limited number of “starter” points to new merchants at no charge, to entice them to adopt the system.

Actions

The actions available in this method include Awarding points, Redeeming points, Donating points, Buying points, and Configuring Awards. In addition, consumers, merchants and charities can view their accounts and transactions.

Awarding Points

A merchant awards points to customers in the following manner:

Step 1) When the customer makes a purchase that makes the customer eligible to be awarded “points,” the customer presents an optical code to an employee of the merchant. The optical code encodes the customer's account along with other information (i.e. the Universal Resource Locator—URL—for the customer interface to the reserve bank's central system, and sometimes a transaction key).

a) In most embodiments, a QR code is used as the optical code. QR code readers are freely available and are becoming well understood by consumers. However, this method is not limited to QR codes; optical code systems other than the QR code may be used for the same purpose. This document uses “QR code” to refer to any such optical code system.

b) In some embodiments, the QR code is printed on physical media, such as a card or keychain tag, which the customer presents to the merchant.

c) In other embodiments, the QR code is displayed on the screen of the customer's mobile device when the customer opens the system's “app”, navigates to the system's web site, or uses a QR reader to scan a QR code displayed by the merchant. (The QR code encodes a URL for the system web site and identifies the merchant.) The customer using their mobile device may be shown a “home screen” that displays their current balance of points at this merchant, any award(s) the customer is eligible to redeem at this merchant (and if not yet eligible, the number of points they need). The customer may also see their total points balance for all merchants, and/or a list of other merchants where the customer has enough points (or close to enough) to redeem a reward. The customer's screen then offers two or three choices: “claim reward” (if eligible), “get points” or “donate points.” The consumer selects “get points” [in this paragraph we are describing how the consumer gets points, the other choices are explained elsewhere] and then a QR code is displayed on the screen of the customer's mobile device, along with instructions to show the code to the merchant. In this on-screen embodiment, unlike the embodiment where the customer's account is encoded on physical media, the displayed QR code can be generated in real-time, and may differ each time. The displayed code, instead of simply encoding the customer's account number, encodes a “pending transaction key.” (The key is a pseudo-random number unlikely to be duplicated intentionally or unintentionally by anyone without access to the database.) The key identifies a record in the database of a pending transaction. The pending transaction record includes all available details of the transaction: the customer, the merchant (if known at this point), the time, and the place (if available), with the remaining details to be filled in when the merchant awards points to the customer. The pending transaction expires, if not completed within a short period of time, in which case the customer must select “get points” again. This embodiment (“c”) may be present in the same system along with the previous embodiment (b, above), so that customers with or without smartphones may participate.

Step 2) An employee of the merchant may use their personal smartphone, or a device belonging to the merchant, to scan the QR code presented by the customer. The QR code is decoded using any commonly-available reader app. The QR code encodes a Universal Resource Locator (URL) for a mobile web site or an “app” through which the reserve bank's central database is accessed, along with the customer's account number or key (in the case of a code printed on physical medium) or a transaction key (in the case of a code displayed in real time on the screen of the customer's mobile device). The merchant is identified to the database by a cookie (in the case of a mobile web application) or other local data (in the case of an “app”) on the employee's smartphone. In some embodiments, a trusted manager may log-in on the smartphone being used by the employee, and specify a time after which the smartphone is automatically logged out, so that an employee using their own smartphone for the task can be prevented from awarding points after they have left the merchant's place of business.

Step 3) A screen is displayed on the employee's smartphone that:

a) Displays the customer's name and photograph, if available. (If the customer's name and photograph are not in the database, the employee is prompted to ask the customer their name, and/or ask permission to take a photo. The employee enters the customer's name, and/or uploads the photo. If the customer's email address or mobile phone number is not yet in the database, the employee is prompted to ask for and enter that information as well.)

b) Allows the employee to specify how many points to award the customer (unless configured to offer one point, or a set number of points, by the merchant)

c) Provides a “submit” or “award points” button to execute the transaction.

Step 4) Once executed, “points” are subtracted from the merchant's account and added to the customer's account. A detailed transaction is recorded, identifying the merchant, the customer, the time, the place (if available), and the number of points transacted.

Step 5) The employee's smartphone displays a confirmation screen, and what to say to the customer (determined by the merchant), such as “Thank you, Mrs. Smith, you need only 3 more points to get a free coffee.” If the customer used their mobile device to display their QR code, the customer's screen may also be updated to confirm for the customer that the transaction has been completed.

Redeeming Points

A customer redeems points for awards as follows:

Step 1) A customers using their mobile device may select “claim reward” from the “home screen” (see Awarding Points—Step 1.c. above). This generates a pending award transaction, the key for which is encoded in a QR code and displayed on the screen of the customer's device. For customers using a QR code printed on physical media, redeeming points is initiated when the customer presents the card or tag bearing the QR code to the merchant's employee, and asks the employee if they are eligible to redeem an award.

Step 2) The employee scans the QR code presented by the customer. The customer's name and photo are shown (if available—if not, the employee is prompted for them, as above, under Awarding Points). If the customer has enough points to be eligible for an award, the details of the award are displayed on the employee's screen. Also displayed is the verbiage the employee says to the customer (e.g., “Congratulations, Mrs. Smith, you've earned a free coffee in exchange for 10 points. Would you like your free coffee now?”); this verbiage is configurable by the merchant, along with the details of the award, and the number of points required to redeem the award.

Step 3) If the customer agrees to claim their reward, the employee selects from the screen the option to “Redeem.” (If the customer does not agree, the employee selects “Not now.” This cancels the pending award transaction, if there was one.) The employee gives the customer their award.

Step 4) Points are deducted from the customer's account and, depending on the embodiment, are:

Destroyed

Transferred, in whole or in part, to the customer's designated charity or charities (if designated)

Transferred, in whole or in part, to the merchant's designated charity or charities (if designated)

Transferred, in whole or in part, to the merchant's account, or

Some combination of the above

Step 5) Verbiage to say to the customer, and instructions to the employee on how to provide the reward, and, if desired by the merchant, how to record the award in the merchant's point-of-sale system, are displayed on the screen of the employee's device. Both the instructions, and the verbiage to say to the customer, are configurable by the merchant. If the customer used a mobile device to display their QR code, a confirmation screen is displayed to the customer on their device.

Donating Points

At the “home screen” for the customer, one option is “donate points.” If the customer selects this option, their point balance at each merchant is displayed. The customer may select a merchant, and may then specify a number of points awarded by that merchant to donate to a selected charity.

Selecting a charity: In some embodiments, the customer may select any participating charity, or even nominate a charity that is not yet participating. In other embodiments, the merchant may limit which charities customers may donate the merchant's points to; these are known as the merchant's “preferred charities.” In this embodiment, if the selected merchant has preferred charities, the customer must select one of the merchant's preferred charities as the recipient of the points that the merchant has awarded to the customer.

Once the customer has specified a charity, a merchant, and the number of points to donate, the customer selects “Donate Now.” The customer's account balances (total points, and merchant-specific points) are reduced by the number of points donated, and the selected charity's account balance is increased by the number of points donated.

Buying Points

All points originate with a reserve bank, and benefit a charity. The reserve bank may sell points to charities, merchants and/or consumers. The reserve bank sells points to charities at a low price, e.g. $0.01 per point, and allows charities to sell points at a higher price. The merchant or consumer may buy points from a charity at the price set by the charity (some embodiments) or at a price set by the reserve bank (other embodiments). In some embodiments, the reserve bank acts as a broker for the sale of points from charities to merchants or consumers.

A merchant or a consumer may buy points from a charity (or, if the reserve bank is acting as broker, from the reserve bank on behalf of a charity, and the charity receives some of the proceeds from the sale).

The consumer or merchant may pay for the points using economic currency ($US), or with social currency ($DF) administered by the reserve bank.

When the reserve bank acts as broker, the charity receives a share of the proceeds. In some embodiments, the reserve bank deposits points in the charity's account; in some embodiments, the reserve bank credits the charity with social currency ($DF); and in some embodiments, the reserve bank pays the charity in economic currency (i.e. $US).

Typically, a charity will not sell points directly, and will use the reserve bank as a broker. Merchants and consumers (and sometimes, other charities) will buy points through the reserve bank, online, specifying a charity as beneficiary. If the beneficiary charity has points in their account (these may be points that the charity purchased, or points donated to them), the reserve bank acts as the charity's agent to sell those points to the buyer. The reserve bank transfers the points from the charity's account to the buyer's account, collects from the buyer the sale price (in $US or $DF), and credits the charity with their share of the $DF or $US collected from the buyer. If the charity does not have points in their account, the reserve bank creates new points to sell to the buyer. In some embodiments, the reserve bank charges a fee for this transaction.

Merchants that have specified “preferred charities” may elect to allow customers who have purchased points from those charities to use those points to claim rewards.

A method to exchange currency (whether social currency, economic currency, or “points”) using mobile network-connected devices (“smartphones”) to read and display optical codes (“QR codes”).

This method uses terms described in the above methods that describe social currency and rewards systems.

In this method, a unique QR code (or other optical code) is issued to an individual, business or organization by the reserve bank or other entity employing this method. There are two types of codes (which may be considered different embodiments) described herein: an unlimited code, and a limited code.

The QR code encodes a Universal Resource Locator (URL). In some embodiments, the URL launches a dedicated “app” that interfaces with the database system where currency is exchanged; this embodiment has the disadvantage of requiring the person scanning the code to have the app installed on their device. In other embodiments, the URL encodes a mobile web page, and uses the browser on the device as the interface. In either embodiment, the URL also encodes two other pieces of information: 1) the receiver's reserve bank's identifier (if not implicit in the app or the mobile web address); and 2), either:

In the case of an unlimited code, the account number or other key identifying the account of the receiver.

In the case of a limited code, a transaction key (described in more detail below, under Limited QR Code).

The receiver's QR code may be printed on physical media anywhere you might find QR codes, or the QR code can be displayed on the screen of a device.

In this method, the receiver does not explicitly authorize each transfer of funds to his account. By displaying the QR code where others can scan it, the receiver permits anyone viewing the code to give money (transfer funds to the receiver's account).

This method is particularly useful for fundraising (though it can be used to transfer money for any purpose). The QR code can be placed on t-shirts, posters, billboards or magazine ads, for example. Anyone can be the “giver;” transferring money to the receiver's account is as simple as scanning the receiver's QR code using a smartphone or other networked computing device equipped with a camera, QR reader software, and a web browser or dedicated app, and following a few simple steps:

STEP 1) If the giver has access to the receiver's QR code, the giver scans the receiver's code to initiate the transfer. The URL encoded in the QR code opens the app or web browser.

STEP 1, alternate) If the giver does not have access to the receiver's QR code, but has the URL, the giver may enter the URL using a keyboard or by clicking an HTML link containing the URL. If the giver does not have the URL, but knows the receiver's account number (or other key identifying the receiver's account), the giver can go to the reserve bank's “home page” and select the option to “give money,” and when prompted, enter the receiver's account number or key.

STEP 2) If the receiver has stored identifying information (such as a name, photo or logo) in the database for public display, that information is displayed on the giver's screen. Having thus confirmed the identity of the receiver, the giver specifies the amount (or if the amount is already specified, agrees to the amount) to be transferred to the receiver's account, and selects “Transfer funds.”

STEP 3) If the giver has an account at the receiver's reserve bank (the reserve bank using this method), or at a reserve bank that is accessible to the system (this method) and integrated with it, the system withdraws the specified amount of funds from the giver's account and deposits the funds into the receiver's account in a single transaction.

STEP 3, alternate) If the giver does not have an account accessible to the receiver's reserve bank using this system, the giver may be prompted for a credit card or other method of currency transfer that is available online, or may be asked for information upon which to base a credit decision. The system then creates a new account for the giver, and funds the account from the giver's credit card or other source of funds, or by extending the giver credit. Then the system transfers the specified amount from the giver's new account to the receiver's account.

Limited QR Codes

In this variation or embodiment, the receiver may request or be issued a QR code that places limits on the transaction(s) that the QR code can be used for. The limited QR code can be good for only a limited period of time, for a limited number of transfers, and/or for a limited or specified amount of money per transfer. In this embodiment, the QR code encodes a pseudo-randomly generated key to a transaction record in the database. The record and the key are created when the receiver opts (via the device's web browser and the reserve bank's mobile web page, or via a dedicated app) to “receive money.” The receiver (and in some embodiments, reserve bank policy) may then limit the uses of the temporary code in several ways, including: how long the temporary code is valid; the number of transactions the code may be used for; the amount of money that may be transferred in a single transaction or from a single giver (a maximum amount, a minimum amount, or a set amount may be specified). These limits are recorded in the transaction record. A key to the record is generated, encoded in a QR code, and displayed on the receiver's device. The receiver may then use the device's screen to display the QR code to the giver, or the receiver may copy the QR code and print it anywhere you might use a QR code. Scanning of the code and transfer of funds from giver to receiver then proceeds in the three-step manner described above.

END OF SECTION TITLED: REWARDS METHODS

All patents and publications mentioned in the prior art are indicative of the levels of those skilled in the art to which the invention pertains. All patents and publications are herein incorporated by reference to the same extent as if each individual publication was specifically and individually indicated to be incorporated by reference, to the extent that they do not conflict with this disclosure.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations, and broad equivalent arrangements.

I claim:

1. A method to provide a currency in a commercial environment, the method comprising:
establishing a reserve bank for the currency;
soliciting non-profit organizations to utilize the currency;
soliciting businesses to accept the currency and to optionally sponsor the non-profit organizations;
supplying an initial amount of the currency to the non-profit organizations and the businesses, wherein the initial amount of the currency supplied is a function of a level of sponsorship that the respective businesses provide to the sponsored non-profit organizations or an amount of the currency that the businesses can be expected to accept;
encouraging the businesses to donate the currency to the non-profit organizations for their reuse;
encouraging the non-profit organizations to provide the currency to individuals in return for donations to the non-profit organizations; and
encouraging the individuals to exchange the currency with the businesses in return for goods and services.

2. The method of claim 1, wherein the businesses do not sponsor a specific nonprofit organization and the reserve bank determines the non-profit organizations which receive a corresponding sponsorship benefit.

3. The method of claim 1, further comprising the step of allowing the businesses to print advertising on the currency they receive.

4. The method of claim 1, further comprising the step of encouraging individuals to donate the currency to non-profit organizations.

5. The method of claim 1, further comprising the step of enabling the businesses to purchase advertising on new currency supplied directly to non-profit organizations or to individuals.

6. The method of claim 1, further comprising the step of maintaining exchange rates between the currency and a common medium of exchange through the reserve bank, wherein the exchange rates are a buy rate and a sell rate.

7. The method of claim 6, further comprising the step of selling the currency to the individuals at the exchange rate.

8. The method of claim 6, further comprising the step of providing a discount to the exchange rate for the non-profit organizations.

9. The method of claim 6, further comprising the step of providing a discount to the exchange rate for the businesses.

10. The method of claim 9, further comprising the step of allowing the businesses to print advertising on the currency.

11. The method of claim 1, wherein the currency can have a redeem through date, beyond which the currency is restricted, wherein the restriction can be a requirement to exchange the currency at reserve bank at a predetermined exchange rate or a requirement to donate the currency to a participating nonprofit organization.

12. The method of claim 11, wherein the currency can have a maturity date, which may be the same or different than the redeem through date, after which the reserve bank will exchange the matured currency for an amount money, or the bank may offer to exchange the mature currency for new currency.

13. The method of claim 12, wherein the businesses do not sponsor a specific nonprofit organization and the reserve bank determines the non-profit organizations which receive a corresponding sponsorship benefit.

14. The method of claim 12, further comprising the step of allowing the businesses to print advertising on the currency.

15. The method of claim 12, further comprising the step of enabling the businesses to advertise on new currency supplied to the non-profit organizations or individuals.

16. The method of claim 12, further comprising the step of maintaining an exchange rate between the currency and a common medium of exchange through the reserve bank.

17. The method of claim 16, further comprising the step of selling the currency to the individuals at the exchange rate.

18. The method of claim 16, further comprising the step of providing a discount to the exchange rate for the non-profit organizations.

19. The method of claim 16, further comprising the step of providing a discount to the exchange rate for the businesses.

20. The method of claim 19, further comprising the step of allowing the businesses to print advertising on the currency.
